(19) United States
(12) Patent Application Publication
(10) Pub. No.: US 2013/0015749 A1
(43) Pub. Date: Jan. 17, 2013

(54) Method for Installing a Side-By-Side Domestic Appliance Combination

(71) Applicants: Josef Hecht, Erlenmoos (DE); Dietmar Blersch, Ertingen (DE); Ralf Schubert, Warthausen (DE); Oliver Weidelener, Alleshausen (DE); Stefan Schweikart, Berkheim-Bonlanden (DE)

(72) Inventors: Josef Hecht, Erlenmoos (DE); Dietmar Blersch, Ertingen (DE); Ralf Schubert, Warthausen (DE); Oliver Weidelener, Alleshausen (DE); Stefan Schweikart, Berkheim-Bonlanden (DE)

(73) Assignee: Liebherr-Hausgerate Ochsenhausen GmbH, Ochsenhausen (DE)

(21) Appl. No.: 13/350,311

(22) Filed: Jan. 13, 2012

(30) Foreign Application Priority Data
Jan. 14, 2011 (DE) 102011008565.3
Feb. 10, 2011 (DE) 102011010907.2

(51) Int. Cl. F25D 23/12; B23P 11/00

(52) U.S. Cl. 312/111; 29/428

(57) ABSTRACT

The present invention relates to a method for installing a side-by-side domestic appliance combination, in particular a side-by-side refrigerator unit and/or freezer unit combination, which comprises at least two domestic appliances or refrigerator and/or freezer units. In accordance with the invention, the method includes the steps: Arranging the two domestic appliances next to one another; placing an installation element onto the upper side of the two domestic appliances arranged next to one another; and fastening of the installation element to both domestic appliances such that the installation element prevents or makes difficult a relative movement of the two domestic appliances in the depth direction and in the height direction.

### BACKGROUND OF THE INVENTION

The present invention relates to a method for installing a side-by-side domestic appliance combination, in particular a side-by-side refrigerator unit and/or freezer unit combination, which comprises at least two domestic appliances or refrigerator and/or freezer units.

Such side-by-side domestic appliance combinations usually comprise two domestic appliances which are arranged next to one another, such as two refrigerator and/or freezer units arranged next to one another.

There is a problem in the installation of such side-by-side domestic appliance combinations in that the two domestic appliances have to be aligned exactly parallel to one another in a plurality of dimensions, in particular in the height and depth directions, which is comparatively complex in known solutions.

### SUMMARY OF THE INVENTION

It is therefore the object of the present invention to further develop a method of the initially named kind such that the installation of a side-by-side domestic appliance combination is possible in a simple manner and with high precision.

This object is achieved by a method having the features herein.

Provision is accordingly made that the method includes the following steps: Arranging the two domestic appliances next to one another; placing an installation element onto the upper side of the two domestic appliances arranged next to one another; and fastening of the installation element to both domestic appliances such that the installation element prevents or makes difficult a relative movement of the two domestic appliances in the depth direction and in the height direction.

One step of the method in accordance with the invention thus comprises the fact of arranging an installation element, for example an installation plate or the like, on the upper side, preferably on the front region of the upper side, of the two domestic appliances roughly arranged next to one another and fixing it to the appliances. This has the result that the appliances are fixed relative to one another in the depth direction and equally in the height direction. It is thus possible to achieve a height alignment and a depth alignment of the two appliances using only one single component. One or also more installation elements can generally be used for this purpose.

An appliance alignment is not necessary since an attachment of all connections elements is possible without problem.

Using the installation element, the two appliances arranged next to one another are aligned so-to-say automatically to one another in height and depth at least in the region of the installation element.

The installation element, which can be designed as a plate, for example, can have one or more projections, webs or the like which project between the two domestic appliances. A specific distance between the appliances can be realized in this manner if it is desired. In this case, the installation element simultaneously serves as a spacer element.

Provision is preferably made that the installation element is fastened to the two domestic appliances by means of one or more screws. It is, for example, conceivable to fix the installation element by a respective one or two screws or by more than two screws per domestic appliance.

Provision is made in a further embodiment of the invention that the installation element is fastened to the side of the upper side of the appliances facing the user of the side-by-side domestic appliance combination. The fastening of the installation element thus takes place in this preferred embodiment at the region of the upper side of the appliances facing toward the front side of the appliances.

Provision is made in a further embodiment of the invention that the method furthermore includes the step of fastening a connection element for the purpose of the depth alignment, preferably in the lower region of the side-by-side domestic appliance combination, with the connection element preferably being fastened to the front side of both domestic appliances in their lower regions. The fastening of the connection element preferably takes place subsequent to the fastening of the installation element.

The connection element can have at least one section which projects into a gap between the domestic appliances and serves as a spacer in this case.

Provision is preferably made that the connection element is screwed to the domestic appliance or appliances. It is conceivable in this respect first to fasten the connection element to one of the appliances and then to “pull in” the other device by tightening the screws so that an alignment is also achieved in the depth direction in the region of the connection element.

Provision is preferably made that the connection element is completely or partly faced by one or more covers.

Provision is made in a further embodiment of the invention that the method furthermore includes the step of connecting the domestic appliances in their rear regions, preferably in their upper and/or lower and/or center rear regions.

It is conceivable that the connection takes place by a clamp connection and/or that the connection of the domestic appliances takes place in their rear regions after the fastening of the installation element and/or after the fastening of the connection element.

The connection can take place by placing one or more clamps, preferably without tools, onto the upper side and/or rear side and/or lower side of both domestic appliances or at any other suitable position.

A particularly simple installation results when the at least one clamp is not fixed by screws and/or if the at least one clamp only connects the domestic appliances by shape-matched fitting or by force-transmitting fitting.

It is thus conceivable to achieve the appliance connection at the rear without tools by, for example, a sheet metal clamp or by a differently designed clamp.

It is thus conceivable to carry out the installation process such that the installation element is first attached, that subsequently a depth alignment or connection of the appliances is carried out at the bottom front side by the connection element and that then the appliance connection on the rear side takes place in that a connection of the appliances to one another is carried out by clamp connections, preferably at the top and/or bottom.

The invention further relates to a side-by-side domestic appliance combination, in particular a side-by-side refrigerator unit and/or freezer unit combination which includes at least two domestic appliances, or refrigerator and/or freezer units, with this side-by-side domestic appliance combination being installed in accordance with a method in accordance with the description herein.

The present invention furthermore relates to a side-by-side domestic appliance combination, in particular a side-by-side refrigerator unit and/or freezer unit combination, which includes at least two domestic appliances, preferably refrigerator and/or freezer units, wherein at least one installation element is provided and wherein the domestic appliances are connected at their upper sides by means of the installation element such that a relative movement of the two domestic appliances in the depth direction and in the height direction is prevented at the fastening position of the installation element.

Provision is preferably made in this respect that the installation element is fastened, preferably screwed, at the front side of the upper side of the domestic appliances facing the user of the side-by-side domestic appliance combination.

The installation element can be a plate, preferably a steel plate or a steel plate with a plastic jacket or with a plastic molding.

Provision is made in a further embodiment of the invention that the combination includes at least one connection element, with the domestic appliances preferably being connected to one another by the connection element at their front sides, preferably in the lower region of their front sides, with the connection element being designed and fastened such that the domestic appliances are fixed relative to one another in the depth direction at the fastening position of the connection element.

At least one clamp is provided in a further aspect of the invention, with the clamp(s) preferably holding the domestic appliances together in their rear regions by shape-matched fitting and/or by force-transmitting fitting.

The invention finally relates to an adjustable foot of a domestic appliance, preferably of a side-by-side domestic appliance combination, in particular of a side-by-side domestic appliance combination in accordance with the description herein, wherein the adjustable foot is provided with a cap, preferably with a plastic cap, at its side directed to the floor which has the advantage that a displacement or sliding of the appliance for the purpose of the arrangement and positioning is simplified. Provision is thus preferably made that the cap is designed such that a displacement of the appliance is possible more easily than without the cap.

The cap additionally acts as a protective cap to avoid possible damage to the floor.

### BRIEF DESCRIPTION OF THE DRAWINGS

Further details and advantages of the invention will be explained with reference to an embodiment shown in the drawing. There are shown:

FIG. 1 a perspective view of the front-side upper region of a side-by-side domestic appliance combination with an installation element;

FIG. 2: a perspective view of the upper region of the side-by-side domestic appliance combination in accordance with FIG. 1 with an installation element shown enlarged;

FIG. 3: a perspective view of the lower region of the side-by-side domestic appliance combination with a connection element arranged at the front side;

FIG. 4: a perspective view of the side-by-side domestic appliance combination with a connection element shown enlarged and a view of a cover;

FIGS. 5, 8: perspective views of the rear lower region of the side-by-side domestic appliance combination with a clamp placed on;

FIGS. 6, 7: a perspective view of the rear top region or upper region of the side-by-side domestic appliance combination with a clamp placed on and a view of this region from the rear;

FIG. 9 a perspective view of the front-side upper region of a side-by-side domestic appliance combination with installed covers;

FIG. 10: a front view of the side-by-side domestic appliance combination in the fully assembled state; and

FIG. 11: two perspective representations of adjustable feet in accordance with the prior art (left hand illustration) and in accordance with the present invention (right hand illustration).

### DESCRIPTION OF THE PREFERRED EMBODIMENTS

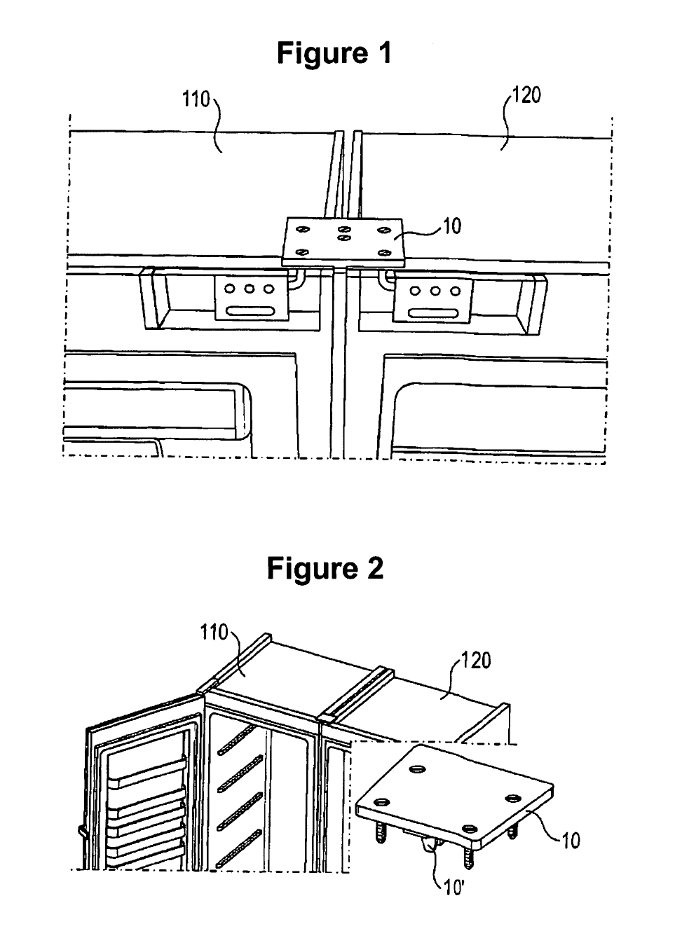

FIG. 1 shows in a perspective view the upper front region of the side-by-side domestic appliance combination which in the embodiment shown here comprises two refrigerator units and/or freezer units arranged next to one another.

It must be pointed out at this point that the present invention is naturally not restricted to exactly two appliances arranged next to one another, but rather also covers an arrangement of more than two such appliances.

For the purpose of the height alignment and depth alignment of the two appliances 110, 120 arranged next to one another, they are first carefully pushed toward one another, roughly prepositioned and then the installation element 10 is introduced from above and is screwed to both appliances 110, 120 after one another.

The installation element 10 in the present embodiment is a steel plate which has a molded plastic cover and which is screwed to the upper covers or the top sides of both appliances 110, 120 with the aid of four screws. The upper beading is shortened.

As can be seen from FIG. 2, the four screws are arranged so that the installation element has two of the screws in a left side region and the two other screws or openings provided therefore in a right side region.

The present invention is naturally not restricted to the use of two screws per appliance 110, 120.

As can further be seen from FIG. 2, a projection 10′ is located in the region between the screws associated with the individual appliances 110, 120 and projects downwardly, that is, in the direction of the screws, from the base installation plate.

With an installed installation plate, this projection 10′ engages into the gap between the two appliances 110, 120 and thus simultaneously serves as a spacing element which ensures a predefined spacing between the two appliances 110, 120 and which also protects against mutual damage of the appliances on the installation.

A first alignment of the appliances is not necessary due to the use of the installation element 10 since an attachment of all connection element is possible without problem after the fastening of the installation element 10.

The two appliances 110, 120 are aligned in the vertical direction, that is so-to-say automatically with respect to one another in the height direction and also in the depth direction, by means of the installation element 10 which serves as a top installation plate.

In a preferred embodiment of the invention, the connection of the front side of the appliances 110, 120 is carried out subsequent to the installation of the installation element 10, and indeed preferably at its lower region, that is in its floor section.

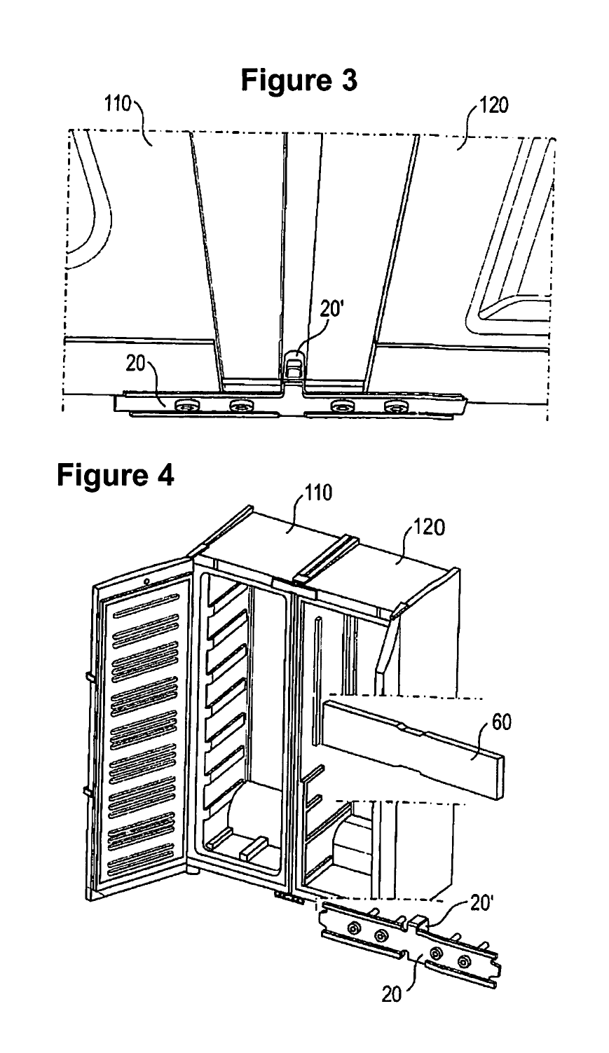

FIG. 3 shows in a perspective view the front base region of both appliances 110, 120 as well as the connection element 20 which can be made as a metal connection sheet. As can also be seen from FIG. 4, the connection element 20 is screwed by means of screws at the front in the lower region, that is in the floor region, of both appliances 110, 120. The connection element 20 can in this respect first be screwed to one of the appliances 110, 120 and the other appliance 120, 110 can then so-to-say be drawn in by the screws so that a depth alignment likewise also takes place automatically in the lower region of the appliances 110, 120.

As can be seen from FIG. 3 and also from FIG. 4, the connection element 20, which can be made as a metal sheet, has a projection 20′ which projects between the two appliances and thus also provides a predefined spacing of both appliances 110, 120 in the lower region of the appliance and provides protection against damage to the appliances 110, 120 during the installation.

The projections 10′ of the installation plate and 20′ of the connection element also ensure the required spacing of the appliances from one another so that the required air circulation can take place.

In a preferred embodiment of the invention, the appliances are parallel to one another in the vertical direction, whereby the required spacing extends equally over the complete appliance height. Provision is therefore preferably made that the appliances are spaced apart from one another over their complete appliance height, with this spacing preferably being identical over the appliance height.

The appliance connection at the rear takes place in the embodiment shown here subsequent to the front depth alignment by means of the connection element 20.

Sheet metal clamps which are placed on without tools in the region of the rear of the appliances serve this purpose in the embodiment shown.

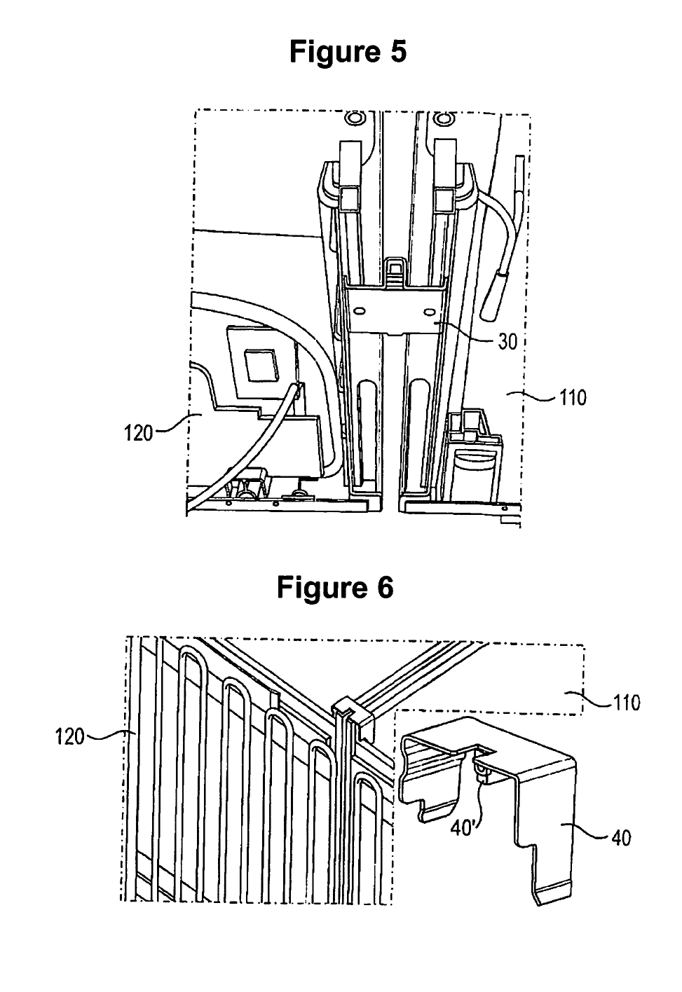

FIG. 5 shows such a sheet metal clamp with the reference numeral 30 which is placed onto the adjacent wall regions of the appliances 110, 120 from the rear. A spacer is marked by the reference numeral 30′ which can be seen better in FIG. 8 and which also ensures a predefined spacing of the appliances in the rear region. The clamp 30 is fixed without tools, and indeed by placing on from behind.

Before or after this step, a connection can be carried out at the rear in the upper region and preferably in the top region of the appliances 110, 120. For this purpose, the sheet metal clamp 40 in accordance with FIG. 6 can be used which fixes both appliances without tools or is placed on without tools by placing on from above. The upper beading can be shortened.

This sheet metal clamp 40 can also have a web, a projection 40′ or another element which projects between the two appliances 110, 120 and also provides a specific parallel spacing apart of the appliances there. This web, projection or the like can preferably extend between the limbs of the clamp 40 made in-U-shape in the same direction as the limb itself.

These statements apply to the clamp 30 and to its projection 30′ accordingly.

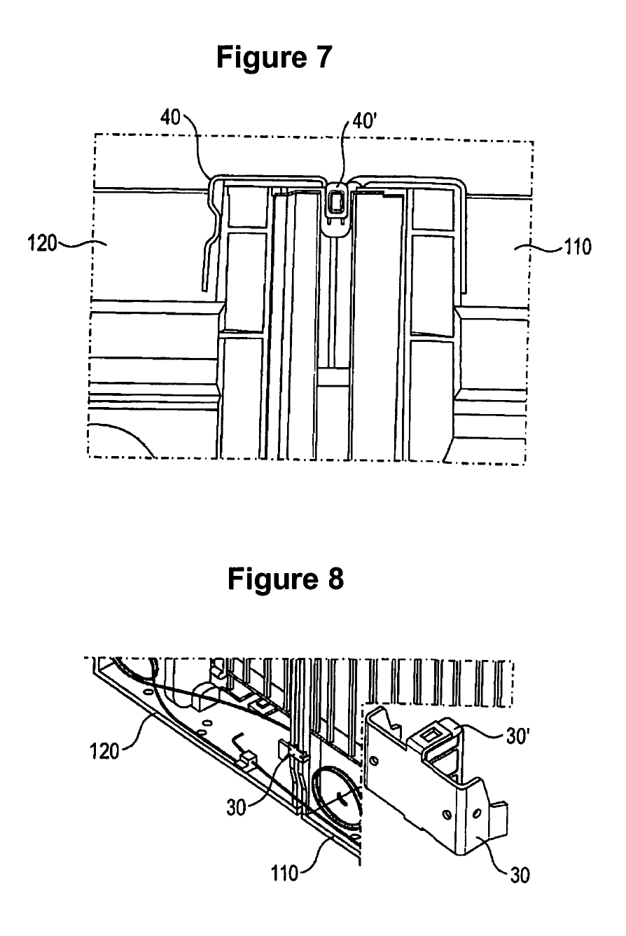

FIG. 7 shows in a view from the rear the placed-on clamp 40 and the spacer of the clamp 40 marked by the reference numeral 40′.

Subsequent to this, an alignment of the total combination shown in FIG. 10 can be carried out. This alignment can take place, for example, such that the center adjustment feet, that is the adjustment feet facing one another, (preferably four pieces) of both appliances are rotated upward so that they lose contact with the floor and so that the total appliance or the total combination is aligned via the respective outer adjustment feet. The center adjustable feet can subsequently again be lowered to contact with the floor so that they can likewise take up a part of the load of the appliance.

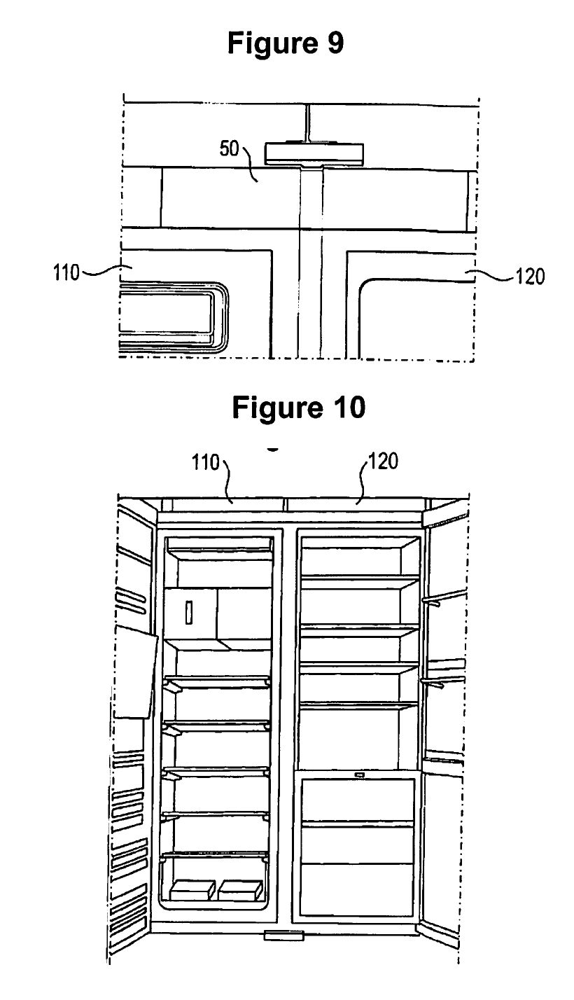

Subsequently, all covers can be clipped on or fastened in another manner, with a cover being marked by the reference numeral 50 in FIG. 9 and a cover being marked by the reference numeral 60 in FIG. 4. Both beadings can thus then be carefully pushed in.

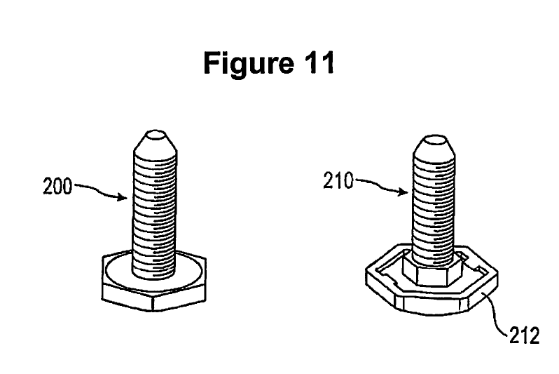

FIG. 11 finally shows in a perspective view an adjustable foot 210 of an appliance 110, 120, with provision preferably being made that the appliances 110, 120 each having four adjustment feet 210 preferably arranged at corner sides. More than four adjustment feet can naturally also be provided per appliance.

To facilitate a sliding in the installation of the total side-by-side domestic appliance combination, provision can now be made that the adjustment foot 210 is provided with a plastic cap or with another cap 212 which establishes the actual gentle floor contact and which is designed so that it slides more easily on the surface than the adjustment foot 210 without such a cap.

A foot 200 in accordance with the prior art without the named cap is shown in FIG. 11, left representation.

1. A method for installing a side-by-side domestic appliance combination, in particular a side-by-side refrigerator unit and/or freezer unit combination, which includes at least two domestic appliances (110, 120), preferably refrigerator and/or freezer units, comprising the following steps:
arranging the two domestic appliances (110, 120) next to one another; and
fastening at least one installation element (10) to the upper side of the two domestic appliances (110, 120) arranged next to one another, with the fastening of the installation element (10) to both domestic appliances (110, 120) being carried out such that the installation element (10) prevents a relative movement of the two domestic appliances (110, 120) at its fastening position in the depth direction and in the height direction.

2. A method in accordance with claim 1, wherein the installation element (10) is fastened by one or more screws to the two domestic appliances (110, 120).

3. A method in accordance with claim 1, wherein the installation element (10) is fastened to the side of the upper side of the two domestic appliances (110, 120) facing the user of the side-by-side domestic appliance combination.

4. A method in accordance with claim 1, wherein the installation element (10) has at least one projection, web or the like; and the installation element (10) is positioned such that the projection, web or the like is located in a gap between the domestic appliances (110, 120).

5. A method in accordance with claim 1, wherein the method furthermore includes the step of fastening a connection element (20) for the purpose of the depth alignment in the lower region of the side-by-side domestic appliance combination, with the connection element (20) preferably being fastened to the front side of both domestic appliances (110, 120) in their lower regions.

6. A method in accordance with claim 5, wherein the fastening of the connection element (20) takes place after the fastening of the installation element (10).

7. A method in accordance with claim 5, wherein the connection element (20) has at least one section which projects into a gap between the domestic appliances (110, 120).

8. A method in accordance with claim 5, wherein the connection element (20) is screwed to the domestic appliance or appliances (110, 120).

9. A method in accordance with claim 1, additionally comprising the step of connecting the domestic appliances (110, 120) in their rear regions, preferably in their upper and/or lower and/or center rear regions.

10. A method in accordance with claim 9, wherein the connection takes place by a clamp connection; and/or the connection of the domestic appliances (110, 120) takes place in their rear regions after the fastening of the installation element (10) and/or after the fastening of the connection element (20).

11. A method in accordance with claim 9, wherein the connection takes place by placing on, preferably by placing one or more clamps (30, 40) without tools onto the upper side and/or rear side and/or lower side of both domestic appliances (110,120).

12. A method in accordance with claim 11, wherein the at least one clamp (30, 40) is not fixed by screws; and/or the at least one clamp (30, 40) connects the domestic appliances (110, 120) only by force transmission and/or shape matching.

13. A side-by-side domestic appliance combination, in particular a side-by-side refrigerator unit and/or freezer unit combination, which includes at least two domestic appliances (110, 120), preferably refrigerator and/or freezer appliances, wherein
the side-by-side domestic appliance combination is installed in accordance with a method of claim 1.

14. A side-by-side domestic appliance combination, in particular a side-by-side refrigerator unit and/or freezer unit combination, which includes at least two domestic appliances (110, 120), preferably refrigerator and/or freezer appliances, wherein
at least one installation element (10) is provided; and
the domestic appliances (110, 120) are connected at their upper sides by the installation element (10) such that a relative movement of the two domestic appliances (110, 120) is prevented at the fastening position of the installation element (10) in the depth direction and also in the height direction.

15. A side-by-side domestic appliance combination in accordance with claim 14, wherein the installation element (10) is fastened, preferably screwed, to the side of the upper side of the domestic appliances (110, 120) facing the user of the side-by-side domestic appliance combination; and/or the installation element (10) is a plate, preferably a steel plate or a steel plate covered with plastic.

16. A side-by-side domestic appliance combination in accordance with claim 14, wherein
at least one connection element (20) is provided; and
the domestic appliances (110, 120) are preferably connected to one another by the connection element (20) at their front sides, preferably in the lower regions of their front sides, with the connection element (20) being formed and fastened such that the domestic appliances (110, 120) are fixed relative to one another at the fastening position of the connection element (20) in the depth direction; and/or
at least one clamp (30, 40) is provided, with the clamp(s) (30, 40) holding together the domestic appliances (110, 120) in their rear regions by shape matching and/or by force transmission.

17. An adjustable foot of a domestic appliance, preferably of a side-by-side domestic appliance combination, in particular a side-by-side domestic appliance combination in accordance with claim 13, wherein the adjustable foot is provided at its side directed to the floor with a cap, preferably with a plastic cap.

18. A side-by-side domestic appliance combination in accordance with claim 15, wherein
at least one connection element (20) is provided; and
the domestic appliances (110, 120) are preferably connected to one another by the connection element (20) at their front sides, preferably in the lower regions of their front sides, with the connection element (20) being formed and fastened such that the domestic appliances (110, 120) are fixed relative to one another at the fastening position of the connection element (20) in the depth direction; and/or
at least one clamp (30, 40) is provided, with the clamp(s) (30, 40) holding together the domestic appliances (110, 120) in their rear regions by shape matching and/or by force transmission.

19. An adjustable foot of a domestic appliance, preferably of a side-by-side domestic appliance combination, in particular a side-by-side domestic appliance combination in accordance with claim 18, wherein the adjustable foot is provided at its side directed to the floor with a cap, preferably with a plastic cap.

20. An adjustable foot of a domestic appliance, preferably of a side-by-side domestic appliance combination, in particular a side-by-side domestic appliance combination in accordance with claim 16, wherein the adjustable foot is provided at its side directed to the floor with a cap, preferably with a plastic cap.
